(19) United States
(12) Patent Application Publication
(10) Pub. No.: US 2002/0034659 A1
(43) Pub. Date: Mar. 21, 2002

(54) Light emitting device

(75) Inventors: Takeshi Nishi, Kanagawa (JP); Satoshi Seo, Kanagawa (JP); Mayumi Mizukami, Kanagawa (JP)

Correspondence Address: COOK, ALEX, McFARRON, MANZO,, CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 09/941,048

(22) Filed: Aug. 28, 2001

(30) Foreign Application Priority Data
Aug. 29, 2000 (JP) 2000-258356

(51) Int. Cl. H05B 33/12

(52) U.S. Cl. 428/690; 428/704; 428/917; 313/504; 313/506

(57) ABSTRACT

There is provided a light emitting device and an electronic appliance, which are light and have low consumption power and superior durability. In an organic EL element in which high light emission efficiency is obtained by converting triplet excitation energy into light to be emitted, a spiro compound having a higher heat resistance than a conventionally used material or an organic compound having high molecular stability is applied. Thus, an organic EL element which is light and has low consumption power and superior durability is obtained. Using this organic EL element, the light emitting device and the electronic appliance are manufactured.

### BACKGROUND OF THE INVENTION

1. Field of the Invention

The present invention relates to a light emitting device including an element (hereinafter referred to as “an organic EL element”) in which a structure sandwiching a thin film layer (hereinafter referred to as “an organic EL layer”) between an anode and a cathode, which is made of an organic compound in which an electroluminescence (hereinafter referred to as “an EL”) is produced, is provided on a substrate. In particular, the present invention relates to a light emitting device including, of organic EL elements capable of converting energy (hereinafter referred to as “triplet excitation energy”) at the time when a triplet excitation state is returned to a ground state into light to be emitted, an organic EL element characterized in that an organic compound having high heat resistance and high molecular stability is introduced into the organic EL layer. Note that a light emitting device in this specification indicates an image display device or a light emitting device using the organic EL element as a light emitting element. Also, a module in which a TAB (tape automated bonding) tape or a TCP (tape carrier package) is attached to the organic EL element, a module in which a printed wiring board is provided in the end of the TAB tape or the TCP, and a module in which an IC (integrated circuit) is directly mounted on the organic EL element by a COG (chip on glass) method are included in the light emitting device.

2. Description of the Related Art

An organic EL element is an element for emitting light by applying an electric field and noted as a next generation flat panel display element because of characteristics such as lightweight, direct current low voltage drive, and fast response. Also, the organic EL element is a self light emission type and has a wide view angle. Thus, it is considered that the organic EL element is effective as the display screen of a mobile telephone.

Here, a light emitting mechanism of the organic EL element will be described. First, an electron injected from a cathode and a hole injected from an anode are moved to counter electrodes by a hopping mechanism. The hopping mechanism may be chemically translated to the expression that electrons are transferred between adjacent molecules (oxidation and reduction). The hole and the electron are recombined in the organic EL layer to form a molecule (hereinafter referred to as “a molecular exciton”) in an excitation state. When the molecular exciton is returned to a ground state, it releases energy to emit light. In order to improve recombination efficiency of a carrier, a method of laminating a carrier transport layer, a carrier blocking layer, a luminescent layer, and the like to separate functions as the structure of the organic EL layer is used.

Here, as the excitation state of the molecular exciton generated by the recombination of the carrier, a singlet state (S*) and a triplet state (T*) are allowed, and it is considered that its statistical generation ratio S*:T*=1:3 (Reference 1: Tetsuo Tustsui, “The Japan Society of Applied Physics, Organic Molecule and Bioelectronics Division, Third Seminar Text”, p.31 (1993)).

However, with respect to a general organic compound, light emission (phosphorescence) in the triplet excitation state (T*) is not observed at a room temperature. This is caused even in the case of the organic EL element and only light emission (fluorescence) in the singlet excitation state (S*) is generally observed. Thus, it is assumed that a theoretical limitation of internal quantum efficiency (ratio of the photon generated to the injected carrier) in the organic EL element is 25% based on evidence of S*:T*=1:3.

Also, all generated lights are not emitted to the outside of the organic EL element and a portion of the lights cannot be picked up because of the refractive indexes inherent to organic EL element constituent substances (organic EL layer, electrodes, and substrate). A ratio of the light picked up to the outside of the organic EL element to the generated light is called light pickup efficiency. It is said that the pickup efficiency is about 20%.

From the above reason, even if all the injected carriers form the molecular excitons, it is said that the theoretical limitation of a ratio of photons (hereinafter referred to as “an external quantum efficiency”) finally picked up in the outside of the organic EL element to the number of injected carriers is 25%×20%=5%. That is, even if all the carriers are recombined, only 5% of the recombined carriers are picked up as light according to calculation.

However, recently, various organic EL elements using an organic compound capable of converting triplet excitation energy into light to be emitted are successively reported and these high light emission efficiencies are noted (Reference 2: D. F. O'Brien, M. A. Baldo, M. E. Thompson and S. R. Forrest, “Improved energy transfer in electrophosphorescent devices”, Applied Physics Letters, Vol. 74, No. 3, 442-444 (1999) and Reference 3: M. A. Baldo, S. Lamansky, P. E. Burrows, M. E. Thompson, and S. R. Forrest, “Very high-efficiency green organic light-emitting devices based on electrophosphorescence”, Applied Physics Letters, Vol. 75, No. 1, 4-6 (1999)).

In Reference 2, it can be characterized in using a metal complex with platinum as 20 main metal (hereinafter referred to as “a platinum complex”). Also, in Reference 3, it can be characterized in using a metal complex with iridium as main metal (hereinafter referred to as “an iridium complex”). Of these, there is an organic EL element in which the theoretical limitation value of the external quantum efficiency as described above greatly exceeds 5%.

When a layer made of a iridium complex and a layer made of DCM2 as known fluorescent pigment are alternately laminated, the triplet excitation energy produced with the iridium complex is transferred to the DCM2 and thus can contribute to light emission of the DCM2 (Reference 4: M. A. Baldo, M. E. Thompson, and S. R. Forrest, “High-efficiency fluorescent organic light-emitting devices using a phosphorescent sensitizer”, Nature (London), Vol. 403, 750-753 (2000)). The light emission of the DCM2 is light emission (fluorescence) in the singlet excitation state. However, it is an advantage that the triplet excitation energy of the iridium complex, which is efficiently produced, can be utilized for the singlet excitation energy of the DCM2 as another molecule.

As described in References 2 to 4, in the organic EL element capable of converting the triplet excitation energy into light to be emitted, higher external quantum efficiency than a conventional element can be achieved. If the external quantum efficiency is increased, light emission intensity is improved. Thus, it is considered that the organic EL element capable of converting the triplet excitation energy into light to be emitted occupies a large share in the future developments as a method for achieving high intensity light emission and high light emission efficiency.

However, with respect to the organic EL elements described in References 2 to 4, there is a problem in an element life. That is, the half life period of the intensity does not reach a practicable level. According to the report example (Reference 5 indicated below) of the element in which Li₂O is inserted into the element structure of Reference 2 as a cathode buffer layer to further improve the light emission efficiency, in the case where an initial intensity is set to be 500 cd/m², the half life period of the intensity is about 170 hours (Reference 5: Tetsuo Tustsui, Moon-Jae Yang, Masayuki Yahiro, Kenji Nakamura, Teruichi Watanabe, Taishi Tsuji, Yoshinori Fukuda, Takeo Wakimoto and Satoshi Miyaguchi, “High Quantum Efficiency in Organic Light-Emitting Devices with Iridium-Complex as a Triplet Emissive Center”, Japanese Journal of Applied Physics, Vol. 38, L1502-L1504 (1999)).

Even when the high intensity and the high light emission efficiency are achieved, an element life is an extremely important factor for practical use. Therefore, it is necessary to improve a time deterioration factor of intensity in a current element structure.

### SUMMARY OF THE INVENTION

An object of the present invention is accordingly to suppress time deterioration of intensity and to increase an element life in an organic EL element capable of converting triplet excitation energy into light to be emitted. Also, another object of the present invention is to provide an organic EL element having high light emission efficiency and higher durability than a conventional element.

Also, an object of the present invention is to provide a light emitting device which is light and has low consumption power and superior durability, using an organic EL element disclosed by the present invention. Further, an object of the present invention is to provide an electronic appliance which is light and has low consumption power and a long period of durability, using such a light emitting device.

Here, the element structure used in Reference 3 is shown in FIG. 1A and its energy band diagram is shown in FIG. 1B. As a hole transport layer 0102, 4,4′-bis[N-(1-naphthyl)-N-phenyl-amino]-biphenyl (hereinafter referred to as “a-NPD”) indicated by the following structural formula (1) is used. As a luminescent material of a luminescent layer 0103, tris(2-phenylpyridine)iridium (hereinafter referred to as “Ir(ppy)₃”) indicated by the following structural formula (2) is used. As a host material of the luminescent layer 0103, 4,4′-dicarbazole-biphenyl (hereinafter referred to as “CBP”) indicated by the following structural formula (3) is used. As a hole blocking layer 0104, bathocuproine (hereinafter referred to as “BCP”) indicated by the following structural formula (4) is used. As an electron transport layer 0105, Alq3 indicated by the following structural formula (5) is used. A substrate 0100 is made of glass, an anode 0101 is made of indium tin oxide (ITO), and a cathode 0106 made of an alloy of Mg and Ag.

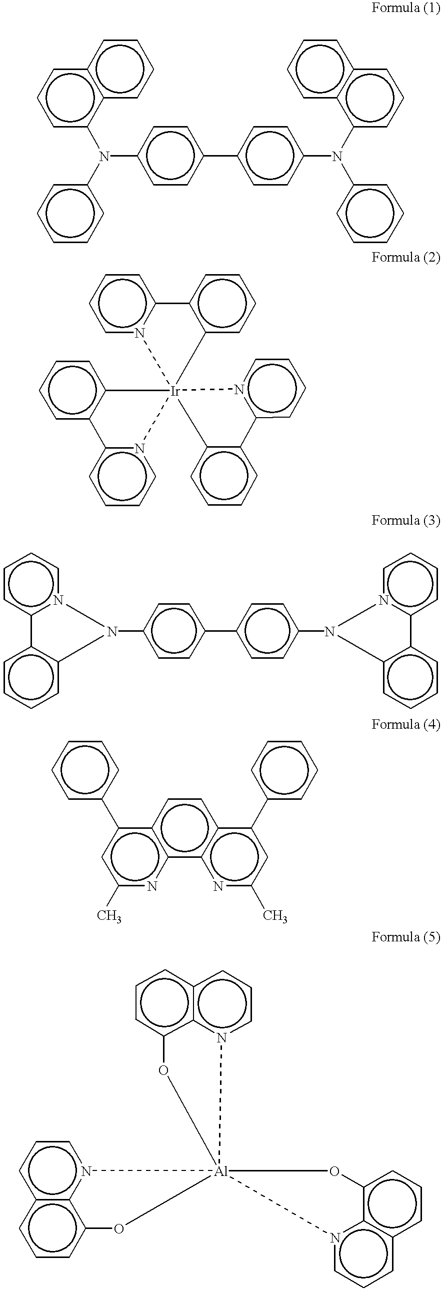

Note that, as can be seen from FIG. 1B, the hole blocking layer is a layer made of a material with a lower HOMO level than that in the luminescent layer and indicates a layer having a function for containing holes in the luminescent layer to efficiently recombine carriers by being provided adjacent to the luminescent layer.

Four materials, A-NPD, CBP, BCP, and Alq₃, which are described above, are used in any one of References 2 to 4. Thus, the element structure shown in FIG. 1A using these materials is applied as a standard to the organic EL element capable of converting the triplet excitation energy into light to be emitted.

The reason that these materials are used is that a material with a suitable electrical characteristic is selected in order to maximize the light emission performance of a platinum complex or an iridium complex. That is, α-NPD has a superior hole transport property and Alq₃ has a superior electron transport property. Also, CBP has a function as a luminescent layer host material having larger excitation energy in order to excite the platinum complex or the iridium complex. Further, BCP has a lower HOMO level than the CBP as the luminescent layer host material to show a superior hole blocking property and thus the recombination of carriers in an adjacent luminescent layer (for example, the luminescent layer 0103 in FIGS. 1A and 1B) can be efficiently produced. Also, the BCP has a function of preventing the diffusion of triplet molecular exciton.

However, it may be said that only the Alq₃ of the electron transport layer has superior durability as an organic EL layer constituent material. With respect to the a-NPD as the hole transport layer, since the glass transition temperature (hereinafter referred to as “Tg”) is lower than 100° C., the heat resistance is low. Thus, since a state of a film is easily changed by joule heat produced in the organic EL layer, a strong influence is provided with respect to element deterioration. Therefore, it is considered that the element deterioration can be suppressed by improving Tg. Also, it is desirable that the CBP as the host material of the luminescent layer has higher Tg.

With respect to the BCP as the hole blocking layer, there is also a problem about Tg. However, there is a larger problem about stability of a molecule itself. That is, there is no stability such as to sufficiently resist the repetition of electron transfer (oxidation and reduction in chemical), and thus a strong influence is provided with respect to element deterioration. Therefore, it is necessary to change the above material into an alternative material having an electrical characteristic capable of blocking holes (that is, a lower HOMO level than the luminescent layer host material) and high molecular stability. Even in this case, it is desirable that the material has higher Tg.

From the above, when a material having high Tg and high molecular stability to oxidation and reduction is used instead of the α-NPD as the hole transport layer, the CBP as the luminescent layer host material, and the BCP as the hole blocking layer, it is considered that the above problem is solved. Note that, as described above, the α-NPD, the CBP, and the BCP each have a superior electrical characteristic. Thus, no large loss of the superior electrical characteristic is essential.

Therefore, the present inventor firstly focuses attention on a spiro compound. The spiro compound is generally called an organic compound such that two rings are covalent with one atom having a tetrahedral geometry (spiro atom). As the spiro atom, carbon, silicon, and the like are known. In particular, of Spiro compounds, a cross type spiro dimer (hereinafter referred to as merely “a spiro dimer”) dimerized by bonding biphenylene to spiro atom such as carbon or silicon is noted in this specification.

As one important characteristic of the spiro dimer, there is the rise of Tg. Thus, this compound will be suitable to achieve an object of the present invention. Note that, it is said that main factors with respect to the rise of Tg are an increase in an amount of molecule by the dimerization and rotation inhibition of biphenylene due to spiro ring formation.

As another important characteristic, there is a matter that electrical characteristics (HOMO-LUMO level, carrier mobility, and the like) of the spiro dimer are almost similar to that of the monomer in the case where carbon is used as the spiro atom. Thus, this will be suitable for the present invention.

From the above, with respect to alternative materials of the A-NPD as the hole transport layer and the CBP as the luminescent layer host material. when a material dimerized with carbon atom as spiro atom is used, Tg can be risen without loss of the electrical characteristics and an element life can be increased.

Therefore, the present invention is characterized in that a spiro dimer of CBP with carbon atom produced as spiro atom is used as a host material of an organic compound capable of converting triplet excitation energy into light to be emitted, for an organic EL element (claim 1).

Also, it is characterized in that a hole transport layer made of a spiro dimer of α-NPD with carbon atom produced as spiro atom is used for an organic EL element capable of converting triplet excitation energy into light to be emitted (claim 3).

Next, with respect to the BCP (molecular stability is low) as a hole blocking layer, even if spiro dimerization is merely made, molecular stability is not improved. Thus, it is suitable that with respect to the BCP, the dimerization is not made but the BCP is replaced by another material having the same hole blocking property and high molecular stability. In this case, a characteristic such as carrier transport property is changed. However, if a hole can be blocked, it can be functioned as a hole blocking layer.

Therefore, the present invention is characterized in that in an organic EL element capable of converting triplet excitation energy into light to be emitted, 3-(4-tert-butylphenyl)-4-phenyl-5-(4-biphenilyl)-1,2,4-triazole (hereinafter referred to as “TAZ”) or 2-(4-biphenilyl)-5-(4-tert-butylphenyl)-1,3,4-oxadiazole (hereinafter referred to as “PBD”), which is a known material, is used as an alternative material of the BCP (claims 5 and 7).

Also, with respect to the TAZ and the PBD, in order to increase Tg, it is preferable that the spiro dimerization is made. The present invention is characterized in that a spiro dimer of TAZ or a spiro dimer of PBD is used for an organic EL element capable of converting triplet excitation energy into light to be emitted (claims 9 and 11).

Note that, with respect to a spiro compound with silicon as spiro atom, an ionization potential tends to increase (HOMO level is decreased). Thus, change in an electrical characteristic can be seen. However, when such a spiro compound is used as a hole blocking layer, it is suitable. Therefore, with respect to the spiro dimer of TAZ and the spiro dimer of PBD, silicon may be used as spiro atom.

### BRIEF DESCRIPTION OF THE DRAWINGS

In the accompanying drawings:

FIGS. 1A and 1B are diagrams showing a structure of an organic EL element;

FIG. 2 is diagrams showing shows a cross sectional structure of a light emitting device;

FIGS. 3A and 3B are diagrams showing a top structure and a cross sectional structure of a light emitting device;

FIGS. 4A to 4C are diagrams showing a top structure and a cross sectional structure of a light emitting device;

FIGS. 5A and 5B are diagrams showing a structure of a light emitting device;

FIGS. 6A and 6B are diagrams showing a structure of a light emitting device;

FIGS. 7A to 7F are diagrams showing concrete examples of an electronic appliance; and

FIGS. 8A and 8B are diagrams showing concrete examples of the electronic appliance.

### DETAILED DESCRIPTION OF THE PREFERRED EMBODIMENTS

With respect to an organic EL element including a luminescent material capable of converting triplet excitation energy into light to be emitted, when the following material is used in the suitable location, an element life can be improved.

First, as an alternative material of CBP as the host material of the luminescent material, a spiro dimer of the CBP (hereinafter referred to as “spiro-CBP”), which is indicated by the following structural formula (6) may be used.

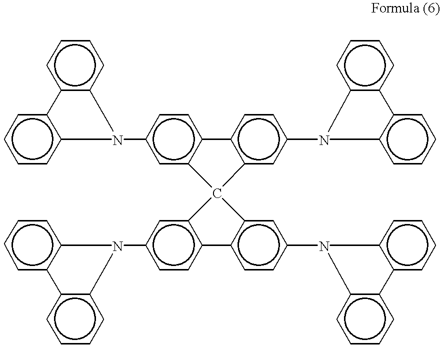

Also, as an alternative material of cc-NPD as the hole transport layer, a spiro dimer of the α-NPD (hereinafter referred to as “spiro-1-NPB”), which is indicated by the following structural formula (7) may be used.

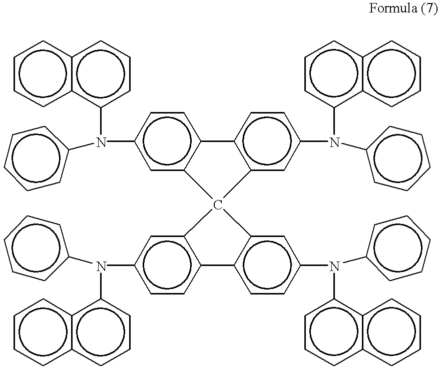

Next, as an alternative material of BCP as the hole blocking layer, TAZ indicated by the following structural formula (8) or PBD indicated by the following structural formula (9) may be used.

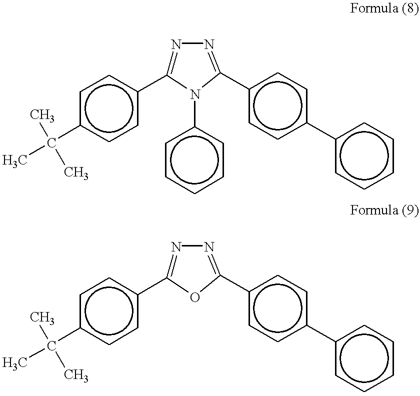

Further, as an alternative material of BCP as the hole blocking layer, a spiro dimer of TAZ (hereinafter referred to as “spiro-TAZ”), which is indicated by the following general formula (10) or a spiro dimer of PBD (hereinafter referred to as “spiro-PBD”), which is indicated by the following general formula (11) may be used. Note that the symbol “A” in the following general formulas (10) and (11) denotes carbon or silicon.

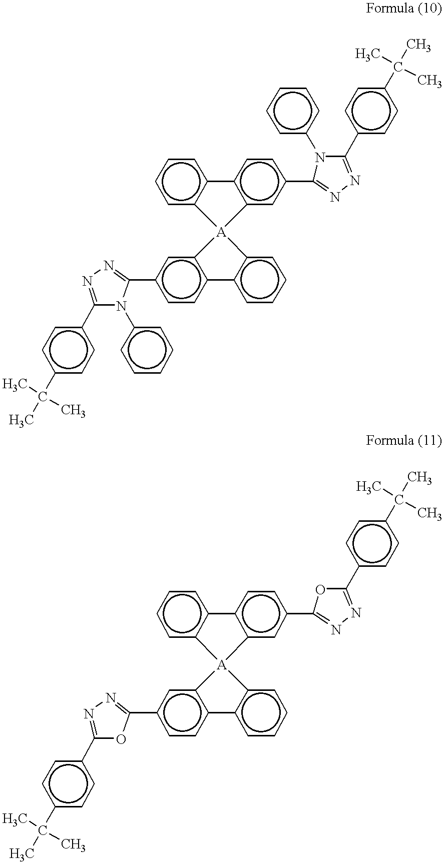

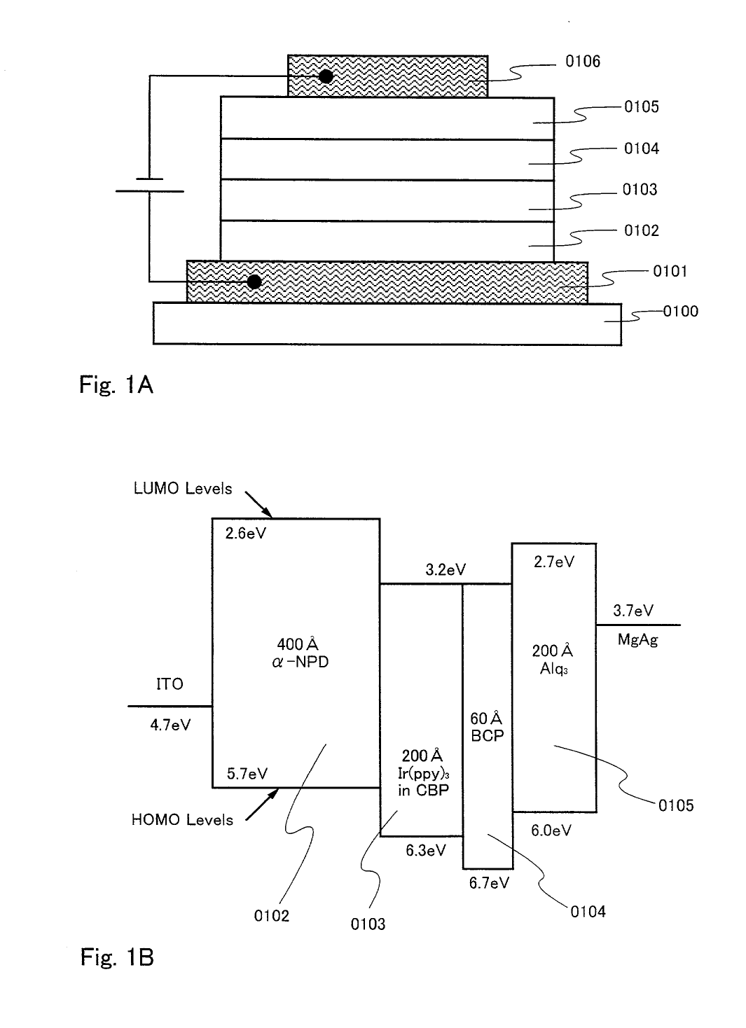

In this embodiment, the above described materials are applied. Further, a method of manufacturing an organic EL element using an iridium complex as a luminescent material capable of triplet excitation energy into light to be emitted will be specifically described. An element structure is similar to that shown in FIG. 1A and symbols in this embodiment are referred to those in FIG. 1A.

First, indium tin oxide (ITO) is formed into a film as an anode 0101 on a substrate 0100 (glass is used here) by sputtering. Next, spiro-1-NPB is formed into a film as a hole transport layer 0102 at a thickness of 400 angstroms by vacuum evaporation.

Further, as a luminescent layer 0103, spiro-CBP as a host material and a known luminescent material Ir(ppy)₃ capable of converting triplet excitation energy into light to be emitted are formed into a film by coevaporation from respective separate evaporation sources. At this time, it is suitable that a weight percent of Ir(ppy)₃ in the luminescent layer 0103 is 5 wt % to 10 wt %. A thickness of the luminescent layer 0103 is set to be 200 angstroms.

After the luminescent layer 0103 is laminated, an organic compound indicated by the following structural formula (12) in which carbon is used as spiro atom “A” in the spiro-TAZ is formed as a hole blocking layer 0104 at a thickness of 60 angstroms. As a material for the hole blocking layer 0104, TAZ, PBD, or spiro-PBD may be used instead of the spiro-TAZ. However, when considering the height of Tg, it is preferable that the spiro-TAZ or the spiro-PBD is used.

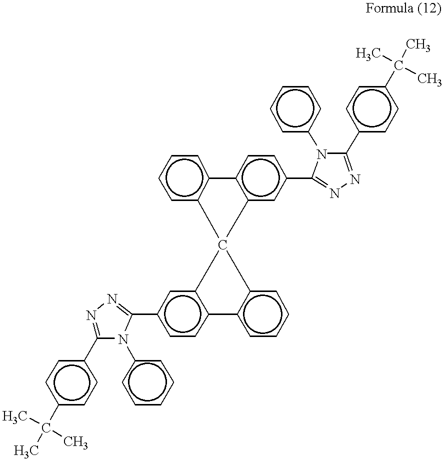

Further, Alq₃ is formed into a film as an electron transport layer 0105 at a thickness of 200 angstroms. Finally, an alloy of Mg and Ag (Mg:Ag=25:1 in mole ratio) having a thickness of 1000 angstroms and Ag having a thickness of 500 angstroms are laminated in this order to form a cathode 0106. As the cathode 0106, a conductive film containing an alkali metal element or an alkali earth metal element or a laminate of that conductive film and an aluminum alloy formed thereon may be used other than the above laminate.

[Embodiment 2]

In this embodiment, the above described materials are applied. Further, a method of manufacturing an organic EL element using a platinum complex as a luminescent material capable of triplet excitation energy into light to be emitted will be specifically described. An element structure is similar to that shown in FIG. 1A and symbols in this embodiment are referred to those in FIG. 1A.

First, indium tin oxide (ITO) is formed into a film as an anode 0101 on a substrate 0100 (glass is used here) by sputtering. Next, spiro-l-NPB is formed into a film as a hole transport layer 0102 at a thickness of 450 angstroms by vacuum evaporation.

Further, as a luminescent layer 0103, spiro-CBP as a host material and a luminescent material 2,3,7,8,12,13,17,18-octaethyl-21H,23H-porphyrin-platinum (hereinafter referred to as “PtOEP”) of the following structural formula (13), which is capable of converting triplet excitation energy into light to be emitted are formed into a film by coevaporation from respective separate evaporation sources. At this time, it is suitable that a weight percent of PtOEP in the luminescent layer 0103 is 4 wt % to 6 wt %. A thickness of the luminescent layer 0103 is set to be 400 angstroms.

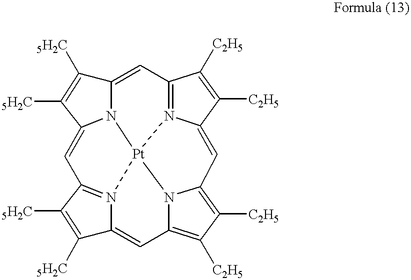

After the luminescent layer 0103 is laminated, an organic compound indicated by the following structural formula (14) in which carbon is used as spiro atom “A” in the spiro-PBD is formed into a film as a hole blocking layer 0104 at a thickness of 80 angstroms. As a material for the hole blocking layer 0104, TAZ, PBD, or spiro-TAZ may be used instead of the spiro-PBD. However, when considering the height of Tg, it is preferable that the spiro-PBD or the spiro-TAZ is used.

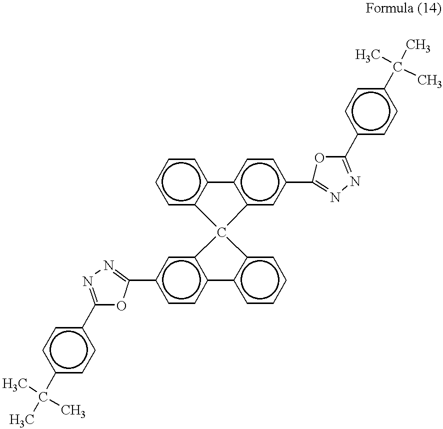

Further, Alq₃ is formed into a film as an electron transport layer 0105 at a thickness of 250 angstroms. Finally, an alloy of Mg and Ag (Mg:Ag=25:1 in mole ratio) having a thickness of 1000 angstroms and Ag having a thickness of 500 angstroms are laminated in this order to form a cathode 0106. As the cathode 0106, a conductive film containing an alkali metal element or an alkali earth metal element or a laminate of that conductive film and an aluminum alloy formed thereon may be used except for the above laminate.

[Embodiment 3]

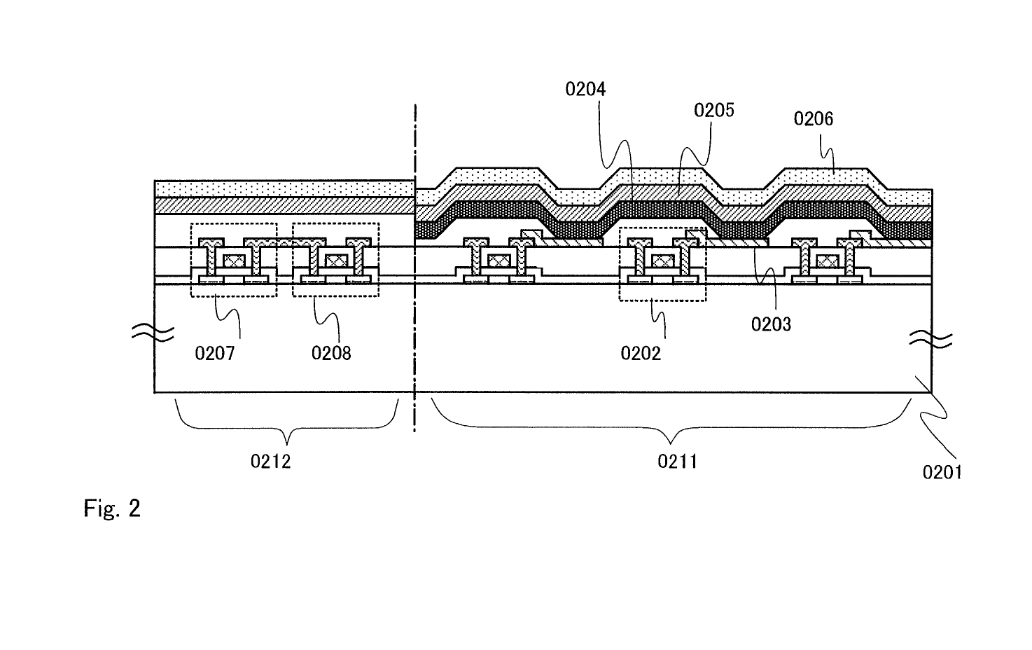

In this embodiment, a light emitting device including the organic EL element disclosed by the present invention will be described. FIG. 2 is a cross sectional view of an active matrix light emitting device using the organic EL element of the present invention. Note that, although a thin film transistor (hereinafter referred to as “a TFT”) is used here as an active element, a MOS transistor may be used.

Also, a top gate TFT (specifically, a planer TFT) is shown as the TFT. However, a bottom gate TFT (typically, an inverse staggered TFT) can be used.

In FIG. 2, reference numeral 0201 denotes a substrate and a substrate which transmits visual light is used here. Specifically, a glass substrate, a quartz substrate, a crystallized glass substrate or a plastic substrate (including a plastic film) may be used. Note that the substrate 0201 includes a substrate in which an insulating film is provided on the surface thereof.

A pixel portion 0211 and a driver circuit 0212 are provided on the substrate 0201. First, the pixel portion 0211 will be described.

The pixel portion 0211 is a region for image display and has a plurality of pixels. A TFT 0202 (hereinafter referred to as “a current control TFT”) for controlling a current flowing into an organic EL element, a pixel electrode (anode) 0203, an organic EL layer 0204, and a cathode 0205 are provided in the respective pixels. Note that, although only the current control TFT is shown in the drawing, a TFT (hereinafter referred to as “a switching TFT”) for controlling a voltage applied to the gate of the current control TFT is also provided.

Here, it is preferable that a p-channel TFT is used as the current control TFT 0202. Although an n-channel TFT can be used, when the p-channel TFT is used in the case where the current control TFT is connected with the anode of the organic EL element as shown in the drawing, consumption power can be further suppressed. Note that either an n-channel TFT or a p-channel TFT may be used as the switching TFT.

Also, the pixel electrode 0203 is electrically connected with the drain of the current control TFT 0202. In this embodiment, a conductive material having a work function of 4.5 to 5.5 eV is used as a material of the pixel electrode 0203. Thus, the pixel electrode 0203 functions as the anode of the organic EL element. As the pixel electrode 0203, typically, indium oxide, tin oxide, zinc oxide, or a compound of these (ITO or the like) may be used. The organic EL layer 0204 is provided on the pixel electrode 0203.

Further, the cathode 0205 is provided on the organic EL layer 0204. A conductive material having a work function of 2.5 to 3.5 eV is used as a material of the cathode 0205. As the cathode 0205, typically, a conductive film containing an alkali metal element or an alkali earth metal element or a laminate of that conductive film and an aluminum alloy formed thereon may be used.

A layer composed of the pixel electrode 0203, the organic EL layer 0204, and the cathode 0205 is covered with a protective film 0206. The protective film 0206 is provided to protect the organic EL element from oxygen and water. As a material of the protective film 0206, silicon nitride, silicon oxynitride, aluminum oxide, tantalum oxide, or carbon (specifically, diamond-like carbon) is used.

Next, the driver circuit 0212 will be described. The driver circuit 0212 is a region for controlling the timing of signals (gate signal and data signal) transmitted to the pixel portion 0211 and a shift register, a buffer, a latch, an analog switch (transfer gate) or a level shifter is provided therein. In the drawing, a CMOS circuit composed of an n-channel TFT 0207 and a p-channel TFT 0208 is shown as a basic unit among these circuits.

Note that a known structure may be used as a circuit structure of the shift register, the buffer, the latch, the analog switch (transfer gate) or the level shifter. Also, in the drawing, the pixel portion 0211 and the driver circuit 0212 are provided on the same substrate.

However, an IC or an LSI can be electrically connected with the pixel portion 0211 without providing the driver circuit 0212 therewith.

Also, in FIG. 2, the pixel electrode (anode) 0203 is electrically connected with the current control TFT 0202. However, a structure in which the cathode is connected with the current control TFT can be used. In this structure, the pixel electrode may be formed of the same material as the cathode 0205 and the cathode may be formed of the same material as the pixel electrode (anode) 0203. In this case, it is preferable that an n-channel TFT is used as the current control TFT.

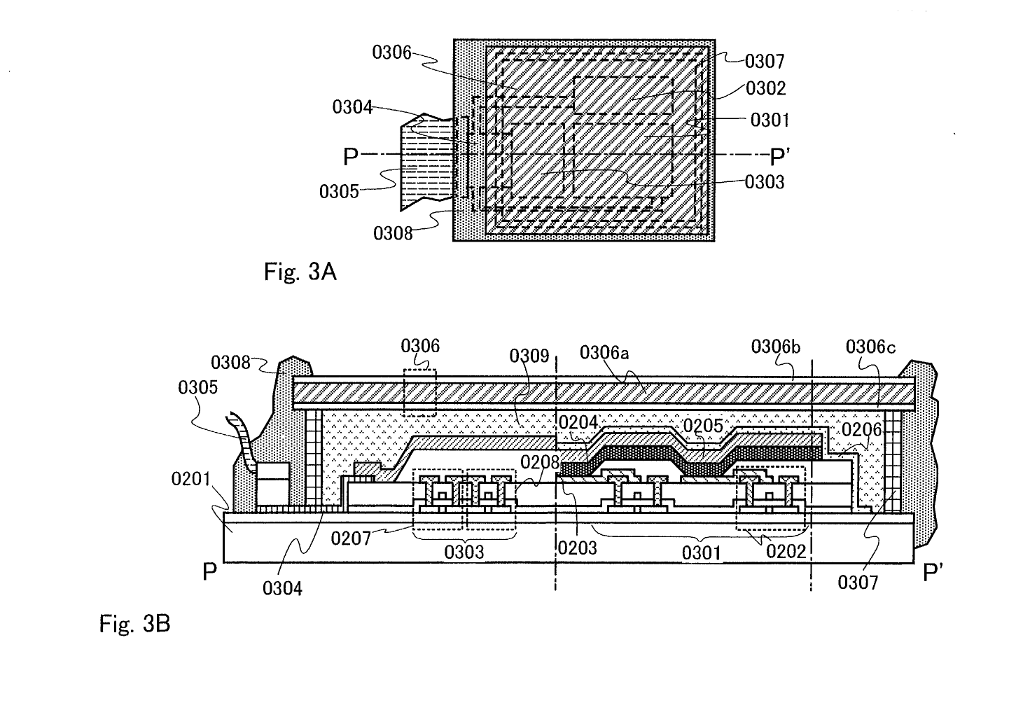

Here, an appearance of the active matrix light emitting device shown in FIG. 2 is shown in FIGS. 3A and 3B. Note that FIG. 3A is a top view and FIG. 3B is a cross sectional view taken along the line P-P′ in FIG. 3A. In addition, symbols in FIG. 2 are referred to.

In FIG. 3A, reference numeral 0301 denotes a pixel portion, 0302 denotes a gate signal side driver circuit, and 0303 denotes a data signal side driver circuit. Also, signals transmitted to the gate signal side driver circuit 0302 and the data signal side driver circuit 0303 are inputted from TAB (tape automated bonding) tape 0305 through an input wiring 0304. Note that, although not shown, instead of the TAB tape 0305, a TCP (tape carrier package) in which an IC (integrated circuit) is provided in the TAB tape may be connected with the input wiring.

At this time, reference numeral 0306 denotes a cover member provided over the light emitting device shown in FIG. 2. The cover member 0306 is adhered to the resultant substrate 0201 through a sealing member 0307 made of resin. The cover member 0306 may be made of a material through which moisture or oxygen is not transmitted. In this embodiment, as shown in FIG. 3B, the cover member 0306 is made from a plastic member 0306a and carbon films (specifically a diamond like carbon films) 0306b and 0306c provided on the front surface and the rear surface of the plastic member 0306a.

Further, as shown in FIG. 3B, the sealing member 0307 is covered with a sealing member 0308 made of resin such that the organic EL element is completely sealed into a closed space 0309. An inert gas (typically, a nitrogen gas or a rare gas), a resin, or an inert liquid (for example, liquid fluorinated carbon which is presented by perfluoroalkane may be filled with the closed space 0309. It is effective that absorbent or deoxidant is provided therewith.

Also, a polarization plate may be provided in a display screen (image viewing surface) of the light emitting device described in this embodiment. This polarization plate has an effect such as the reflection of light entered from the external is suppressed and it is prevented a viewer from being reflected in the display screen. Generally, a circular polarization plate is used. Note that, in the case where it is prevented light emitted from the organic EL layer from being reflected by the polarization plate and retuned to the inner portion, it is preferable to use a structure such that the refractive index is adjusted to reduce inner reflection.

Note that, as the organic EL element included in the light emitting device of this embodiment, any one of the organic EL elements disclosed by the present invention may be used.

[Embodiment 4]

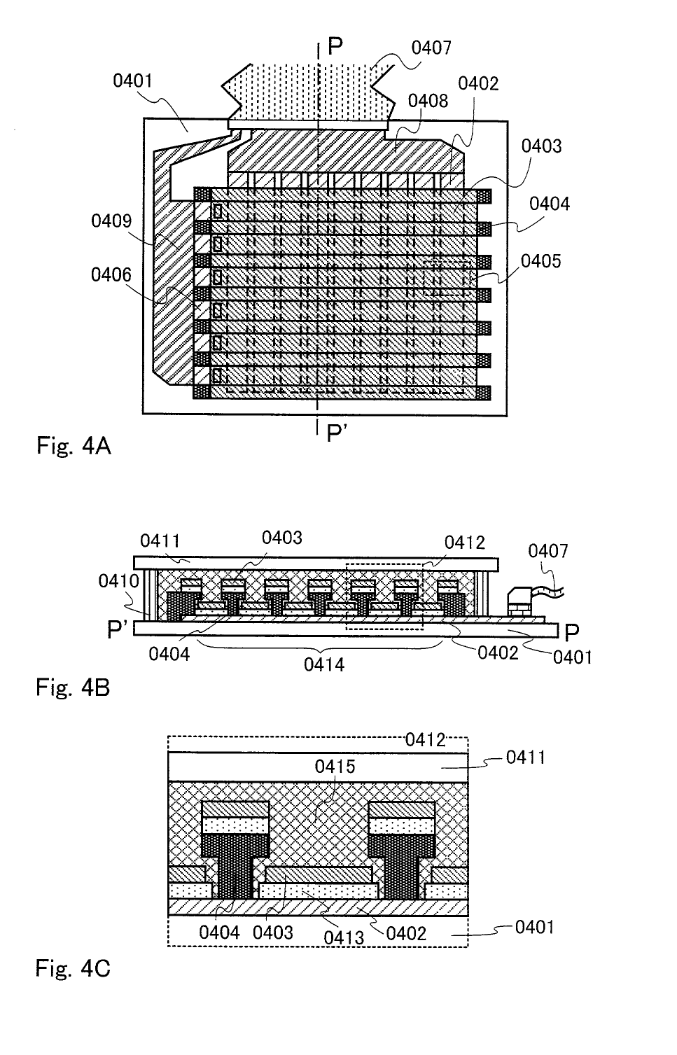

In this embodiment, an active matrix light emitting device will be described as an example of a light emitting device including the organic EL device disclosed by the present invention. FIG. 4A in a top view thereof, FIG. 4B is a cross sectional view obtained by cutting along A dashed line P-P′ in FIG. 4A.

In FIG. 4A, reference numeral 0401 denotes a substrate and a plastic member is used here. As the plastic member, a plate shaped or a film shaped member made of polyimide, polyamide, acrylic resin, epoxy resin, PES (polyethylene sulfate), PC (polycarbonate), PET (polyethylene terephthalate) or PEN (polyethylene naphthalate) can be used.

Reference numeral 0402 denotes scan lines (anodes) made from conductive oxide films. In this embodiment, conductive oxide films in which gallium oxide is added to zinc oxide are used. Reference numeral 0403 denotes data lines (cathodes) made from metal films. In this embodiment, bismuth films are used. Reference numeral 0404 denotes banks made of acrylic resins. The banks 0404 function as isolation walls for separating the data lines 0403. Both the scan lines 0402 and the data line 0403 are formed with stripe shapes and provided orthogonal to each other. Note that, although not shown in FIG. 4A, an organic EL layer is provided between the scan lines 0402 and the data lines 0403 and thus intersection portions 0405 become pixels.

The scan lines 0402 and the data lines 0403 are connected with an external driver circuit through a TAB tape 0407. Note that reference numeral 0408 denotes a wiring group made from a set of scan lines 0402 and reference numeral 0409 denotes a wiring group made from a set of connection wirings 0406 connected with the data lines 0403. Also, although not shown, instead of the TAB tape 0407, a TCP in which an IC is provided in the TAB tape may be connected with the scan lines and the data lines.

In FIG. 4B, reference numeral 0410 denotes a sealing member and 0411 denotes a cover member adhered to the plastic substrate 0401 through the sealing member 0410. A light curable resin may be used as the sealing member 0410 and a material in which degassing is less and which has low hygroscopicity is preferable. It is preferable that the cover member is made of the same material as the substrate 0401 and glass (including quartz glass) or plastic can be used. Here, a plastic member is used.

Next, an enlarged view of a structure of a pixel region is shown in FIG. 4C. Reference numeral 0413 denotes an organic EL layer. Note that, as shown in FIG. 4C, banks 0404 are formed with a shape in which a width of the lower layer is narrower than that of the upper layer, and thus the data lines 0403 can be physically separated form each other. A pixel portion 0414 surrounded by the sealing member 0410 is blocked from external by a sealing member 0415 made of resin, and thus a structure is obtained such that deterioration of the organic EL layer is prevented.

In the light emitting device of the present invention having the above structure, the pixel portion 0414 is constructed by the scan lines 0402, the data lines 0403, the banks 0404, and the organic EL layer 0413. Thus, the light emitting device can be manufactured by a very simple process.

Also, a polarization plate may be provided in a display screen (image viewing surface) of the light emitting device described in this embodiment. This polarization plate has an effect that the reflection of light incident from external is suppressed and it is It prevented that a viewer is reflected in the display screen. Generally, a circular polarization plate is used. Note that, in the case where it is prevented that light emitted from the organic EL layer is reflected by the polarization plate and retuned to the inner portion, it is preferable to use a structure such that the refractive index is adjusted to reduce inner reflection.

Note that, as the organic EL element included in the light emitting device of this embodiment, any one of the organic EL elements disclosed by the present invention may be used.

[Embodiment 5]

In this embodiment, an example of a module in which a printed wiring board is provided in the light emitting device described in Embodiment 4 will be described.

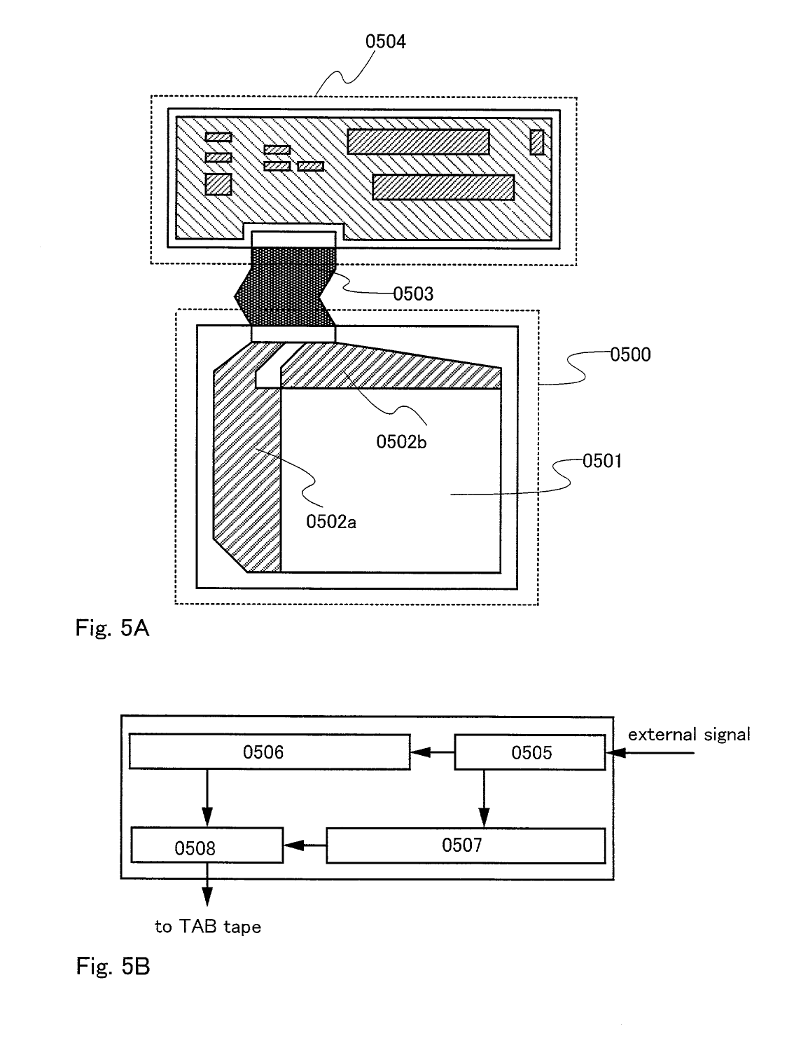

In a module shown in FIG. 5A, a TAB tape 0503 is attached to a substrate 0500 (here, including a pixel portion 0501 and wirings 0502a and 0502b) and a printed wiring board 0504 is attached to the substrate 0500 through the TAB tape 0503.

Here, a functional block view of the printed wiring board 0504 is shown in FIG. 5B. An IC which functions as at least I/O ports (input portion and output portion) 0505 and 0508, a data signal side driver circuit 0506, and a gate signal side driver circuit 0507, is provided in the inner portion of the printed wiring board 0504.

Therefore, the module in which the TAB tape is attached to the substrate in which the pixel portion is formed on a substrate surface and the printed wiring board having a function as the driver circuit is attached to the substrate through the TAB tape is called a driver circuit external module in particular in this specification.

Note that, as the organic EL element included in the light emitting device of this embodiment, any one of the organic EL elements disclosed by the present invention may be used.

[Embodiment 6]

In this embodiment, an example of a module in which a printed wiring board is provided in the light emitting device described in Embodiment 3 or 4 will be described.

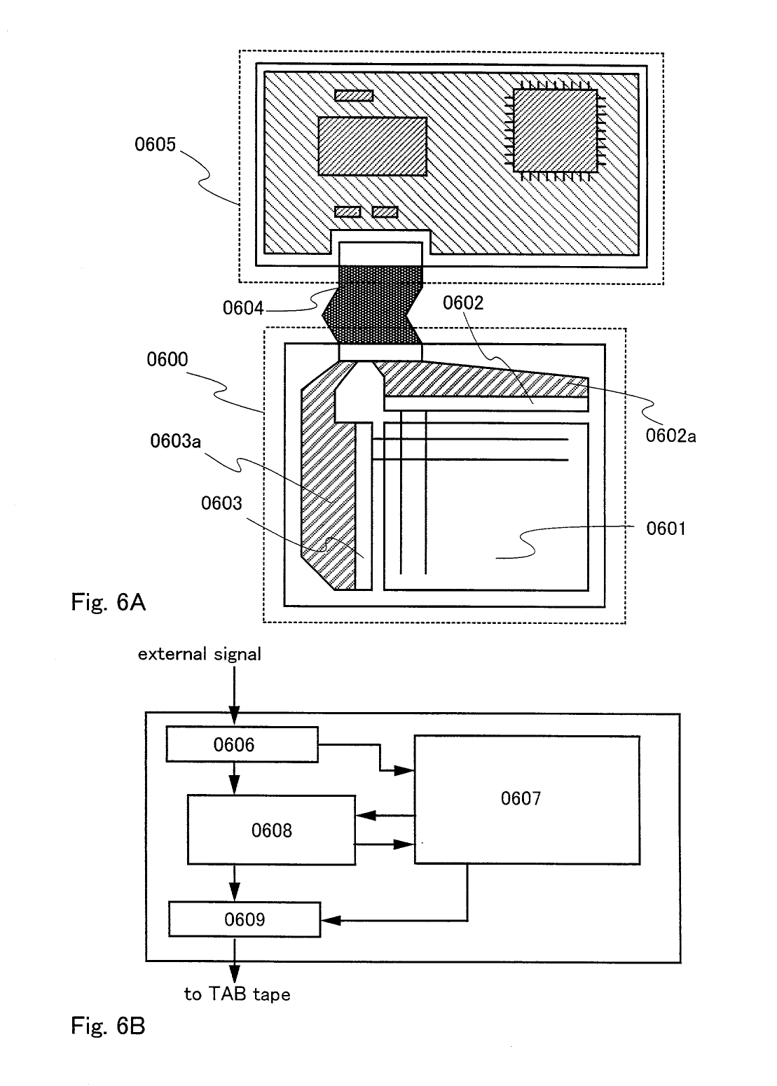

In a module shown in FIG. 6A, a TAB tape 0604 is attached to a substrate 0600 (here, including a pixel portion 0601, a data signal side driver circuit 0602, a gate signal side driver circuit 0603, and wirings 0602a and 0603a) and a printed wiring board 0605 is attached to the substrate 0600 through the TAB tape 0604. A functional block view of the printed wiring board 0605 is shown in FIG. 6B.

As shown in FIG. 6B, an IC which functions as at least I/O ports 0606 and 0609 and a control portion 0607 is provided in the inner portion of the printed wiring board 0605. Note that, although a memory portion 0608 is provided here, it is not necessarily provided. Also, the control portion 0607 has a function of controlling operations of the driver circuits, correction of image data, and the like.

Therefore, the module in which the printed wiring board having a function as the controller is attached to the substrate in which the organic EL element is formed is called a controller external module in particular in this specification.

Note that, as the organic EL element included in the light emitting device of this embodiment, any one of the organic EL elements disclosed by the present invention may be used.

[Embodiment 7]

Since the light emitting device of the present invention is a self light emission type, this light emitting device has characteristics such as high visibility in a light place and a wide view angle, compared to a liquid crystal display device. Therefore, it is effective that this light emitting device is used as a display portion of various electronic appliances.

Also, since the light emitting device of the present invention has advantages such as being light and having low consumption power, it is useful as a light source of various electronic appliances. Typically, the light emitting device can be used as a light source such as a back light or a front light of the liquid crystal display device or a light source of an illumination equipment.

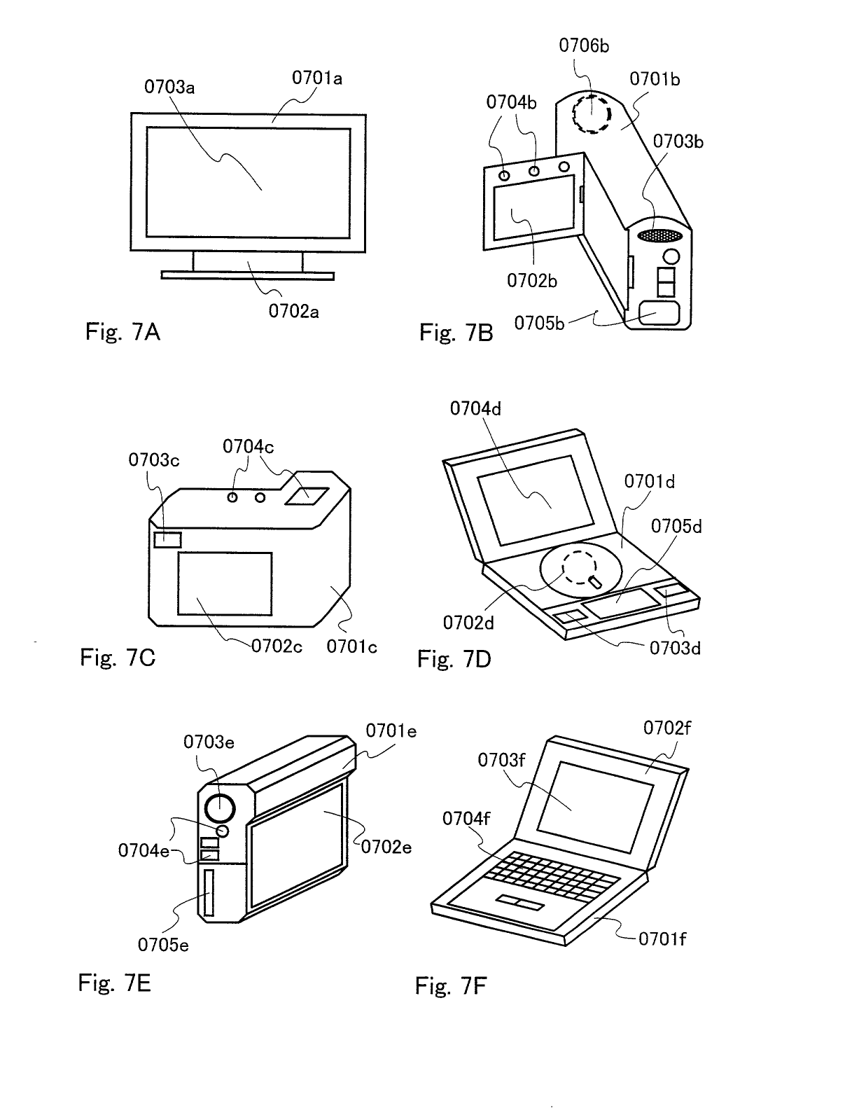

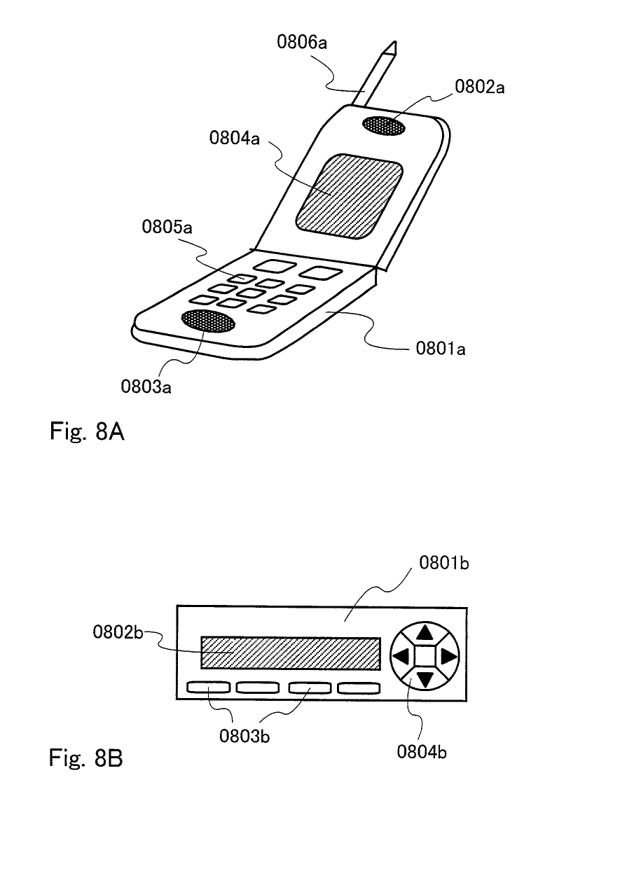

In this embodiment, an example of an electronic appliance in which the light emitting device of the present invention is used for a display device will be described. Concrete examples are shown in FIGS. 7A to 7F and 8A and 8B. Note that any one of the organic compounds (organic compounds indicated by structural formulas (6) to (9) and general formulas (10) and (11)) disclosed by the present invention may be used for an organic EL element included in the electronic appliance of this embodiment. Also. as the light emitting device included in the electronic appliance of this embodiment, any one of the light emitting devices shown in FIGS. 2 to 6B may be used.

FIG. 7A shows an organic EL display device including a cabinet 0701a, a support base 0702a, and a display portion 0703a. The light emitting device of the present invention can be used for the display portion 0703a. Since the organic EL display device is a self light emission type, the back light is not required. Also, compared with the liquid crystal display device, a thin display portion can be manufactured and lightweight of the display device itself can be made.

FIG. 7B shows a video camera including a main body 0701b, a display portion 0702b, a voice input portion 0703b, an operational switch 0704b, a battery 0705b, and an image receiving portion 0706b. The light emitting device of the present invention can be used for the display portion 0702b.

FIG. 7C shows a digital camera including a main body 0701C, a display portion 0702c, an eyepiece portion 0703c, an operational switch 0704c. The light emitting device of the present invention can be used for the display portion 0702c.

FIG. 7d shows an image reproduction apparatus having a recording medium. The image reproduction apparatus includes a main body 0701d, a recording medium (CD, LD, DVD, or the like) 0702d, an operational switch 0703d, a display portion (A) 0704d, and a display portion (B) 0705d. The display portion (A) 0704d displays mainly image information and the display portion (B) 0705d displays mainly character information. The light emitting device of the present invention can be used for the display portion (A) 0704d and the display portion (B) 0705d. The image reproduction apparatus having the recording medium includes a CD reproduction apparatus, a game equipment, and the like.

FIG. 7E shows a portable (mobile) computer including a main body 0701e, a display portion 0702e, an image receiving portion 0703e, an operational switch 0704e, and a memory slot 0705e. The light emitting device of the present invention can be used for the display portion 0702e. This portable computer can record information in a recording medium into which a flash memory and a non-volatile memory are integrated and reproduce the information.

FIG. 7F shows a personal computer including a main body 0701f, a cabinet 0720f, a display portion 0703f, and a keyboard 0704f. The light emitting device of the present invention can be used for the display portion 0703f.

In many cases, the above electronic appliance displays information distributed through an electronic communication line such as Internet and a radio communication such as radio wave. In particular, the case where dynamic image information is displayed is increased. A response speed of the organic EL material is very high, and thus it is suitable for such dynamic image display.

Next, FIG. 8A shows a mobile telephone including a main body 0801a, a voice output portion 0802a, a voice input portion 0803a, a display portion 0804a, an operational switch 0805a, and an antenna 0806a. The light emitting device of the present invention can be used for the display portion 0804a.

FIG. 8B shows an acoustic equipment (specifically, an audio for vehicles), including a main body 0801b, a display portion 0802b, and operational switches 0803b and 0804b. The light emitting device of the present invention can be used for the display portion 0802b. In this embodiment, the vehicle setting audio is described as an example. However, the light emitting device may be used for an audio for houses.

It is effective that a photo sensor is incorporated and a means for detecting brightness in a use environment is provided and a function such that a light emission intensity is modulated in accordance with the brightness in the environment for use is provided. If the intensity with a contrast ratio of 100 to 150 can be obtained, compared with the brightness in the environment for use, a user can recognize an image or character information without causing a problem. That is, when the environment for use is light, the intensity of the image can be increased such that it is easy to view. On the other hand, when the environment for use is dark, the intensity of the image can be decreased and thus consumption power can be suppressed.

Note that, even in the case where the liquid crystal display device is used as the display portion of all the electronic appliances which are described in this embodiment and shown in FIGS. 7A to 8B, the light emitting device of the present invention can be used as the back light or the front light of the liquid crystal display device.

When the present invention is embodied, the light emitting device which is light and has low consumption power and superior durability can be obtained. Further, when such a light emitting device is used for a light source or a display portion, the electronic appliance which is light and has low consumption power and a long useful time can be obtained.

What is claimed is:

1. A light emitting device comprising an organic electroluminescence element, said electroluminescence element comprising:
an organic luminescent layer capable of converting triplet excitation energy into light to be emitted; and
a host material for said organic luminescent layer,
wherein said host material is expressed by the following formula.

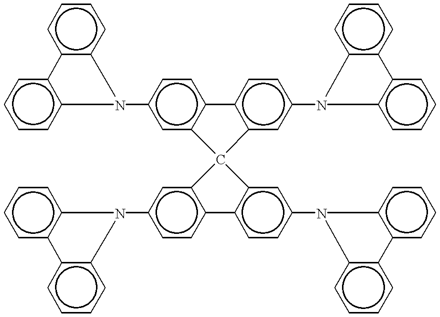

2. An electronic appliance comprising said light emitting device according to claim 1, wherein said electronic appliance is selected from the group consisting of an organic electroluminescence display, a video camera, a digital camera, a portable computer, a personal computer, a mobile telephone, and an acoustic equipment.

3. A light emitting device comprising an organic electroluminescence element, said electroluminescence element comprising:
at least a hole transport layer; and
an organic luminescent layer adjacent to said hole transport layer, said organic luminescent layer being capable of converting triplet excitation energy into light to be emitted; and
wherein said hole transport layer is expressed by the following formula.

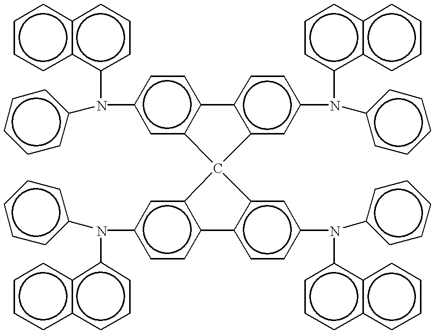

4. An electronic appliance comprising said light emitting device according to claim 3, wherein said electronic appliance is selected from the group consisting of an organic electroluminescence display, a video camera, a digital camera, a portable computer, a personal computer, a mobile telephone, and an acoustic equipment.

5. A light emitting device comprising an organic electroluminescence element, said electroluminescence element comprising:
at least an organic luminescent layer capable of converting triplet excitation energy into light to be emitted; and
a hole blocking layer provided adjacent to said luminescent layer,
wherein said hole blocking layer is expressed by the following formula.

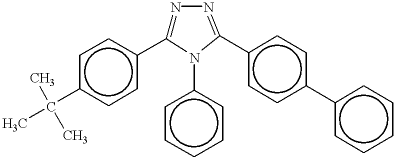

6. An electronic appliance comprising said light emitting device according to claim 5, wherein said electronic appliance is selected from the group consisting of an organic electroluminescence display, a video camera, a digital camera, a portable computer, a personal computer, a mobile telephone, and an acoustic equipment.

7. A light emitting device comprising an organic electroluminescence element, said electroluminescence element comprising:
at least an organic luminescent layer capable of converting triplet excitation energy into light to be emitted; and
a hole blocking layer provided adjacent to said luminescent layer,
wherein said hole blocking layer is expressed by the following formula.

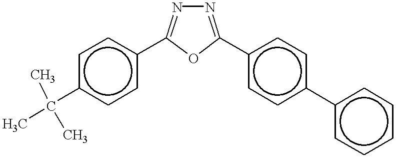

8. An electronic appliance comprising said light emitting device according to claim 7, wherein said electronic appliance is selected from the group consisting of an organic electroluminescence display, a video camera, a digital camera, a portable computer, a personal computer, a mobile telephone, and an acoustic equipment.

9. A light emitting device comprising an organic electroluminescence element, said electroluminescence element comprising:
at least an organic luminescent layer capable of converting triplet excitation energy into light to be emitted; and
a hole blocking layer provided adjacent to said luminescent layer,
wherein said hole blocking layer is expressed by the following formula, and
wherein “A” indicates one of carbon or silicon.

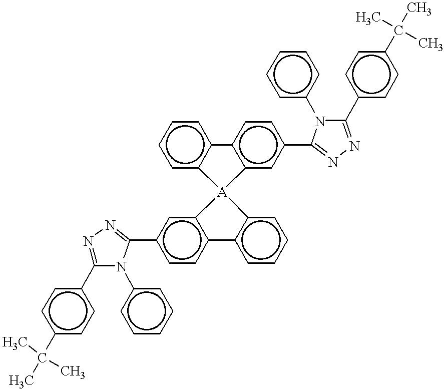

10. An electronic appliance comprising said light emitting device according to claim 9, wherein said electronic appliance is selected from the group consisting of an organic electroluminescence display, a video camera, a digital camera, a portable computer, a personal computer, a mobile telephone, and an acoustic equipment.

11. A light emitting device comprising an organic electroluminescence element, said electroluminescence element comprising:
at least an organic luminescent layer capable of converting triplet excitation energy into light to be emitted; and
a hole blocking layer provided adjacent to said luminescent layer,
wherein said hole blocking layer is expressed by the following formula, and
wherein “A” indicates one of carbon or silicon.

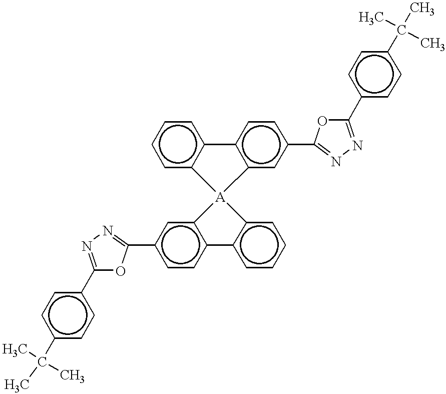

12. An electronic appliance comprising said light emitting device according to claim 11, wherein said electronic appliance is selected from the group consisting of an organic electroluminescence display, a video camera, a digital camera, a portable computer, a personal computer, a mobile telephone, and an acoustic equipment.
